(19) United States
(12) Patent Application Publication
(10) Pub. No.: US 2004/0052992 A1
(43) Pub. Date: Mar. 18, 2004

(54) Biodegradeable shrink wrap

(76) Inventors: Adele Boone, Newton, MA (US); William H. Noon, Boston, MA (US)

Correspondence Address: Samuels, Gauthier & Stevens LLP, Suite 3300, 225 Franklin Street, Boston, MA, 02110, US

(21) Appl. No.: 10/642,252

(22) Filed: Aug. 15, 2003

Related U.S. Application Data
(62) Division of application No. 09/527,489, filed on Mar. 16, 2000, now abandoned.

(51) Int. Cl. F16B 4/00

(52) U.S. Cl. 428/35.1

(57) ABSTRACT

A biodegradable anastomer fabricated with a biodegradable polymer. The polymeric composition includes a mixture or copolymer of lactic acid and polyglycolic acid. The polymeric composition is preferably at least 75% lactic acid by weight, and more preferably at least 85% lactic acid by weight. The polymeric composition may be used to formulate a biodegradable thermo-conforming film used for anastomosi.

### BACKGROUND OF THE INVENTION

The invention relates generally to a biodegradable shrink wrap adapted for use as a surgical anastomosis-aiding device.

Bone is a fundamental source of human structural stability. It provides support for both organs and muscles, gives the body shape and enables movement through attachment to muscles and other tissues. There are five classes of bone fractures, the two most serious types being comminuted and compound fractures. Bones crushed or broken into two or more fragments are termed comminuted, while compound fractures occur when bone pierces through skin. Both types can result in non-union or delayed union fractures where the bone does not join or heal completely. These fractures almost always require surgical treatment.

The most direct method of restoring function after a comminuted or compound fracture, is with internal or external fixation using pins and screws. The fixtures gives strength to the limb so that activity may quickly resume, i.e. the patient can begin to walk on a fractured tibia. In external fixation, the bone is secured at each end of the fracture by metal pins. The pins are attached to metal bars that extend over the fracture, providing structural support while the bone heals. This method has several shortcomings resulting in the lengthening or shortening of the fractured bone. The use of this method also shields the healing bone from stress, yielding mechanically inferior new bone which may lead to the bone being refractured. Furthermore, the interference of impinging tissue into the bone void or regeneration zone inhibits healing and decreases bone strength.

With delayed union or non-union fractures a surgeon may use implants or grafts to fill the voids. When bone fragments are present, the surgeon often attempts to reconstruct the bone by filling the void with the fragments. The process is complicated and traumatic, as surgeons attempt to screw each piece of crushed bone into place. This method increases the amount of foreign material within the body and can be troublesome to the patient as screws are haphazardly drilled throughout the bone. Bone grafts may also be used to fill the voids wherein bone from a donor site is placed into the void to aid in the fusion of the two ends of the fracture. The surgeon must keep the graft within the void.

U.S. Pat. No. 4,470,415 entitled Sutureless Vascular Anastomosis Means and Method is directed to sutureless anastomosis employing a shrink wrap which must be utilized in a particular surgical method. In this reference, the ends of blood vessels are everted over rigid or semi-rigid ferrules placed near the ends of the blood vessels. Then a heat shrinkable sleeve is placed over the everted ends before being shrunk to hold the tubular members in an anastomotic relationship. U.S. Pat. No. 5,866,634 patent entitled Biodegradable Polymer Compositions and Shrink Films focuses on a shrink wrap which decomposes under the natural environment.

A biodegradable thermo-conforming anastomosis-aiding device may be fabricated using polymeric materials. Crystallites are small volumes in which portions of the polymer chains align into a tightly packed crystal lattice. Due to limiting packing arrangements, polymers can never be completely crystalline. Semi-crystalline polymers exhibit glass transition (T_{g}) and crystalline melting (Tₘ) temperatures. T_{g} is the temperature at which coordinated motion is exhibited in the polymer, whereas Tₘ is the temperature where the crystalline regions are no longer stable. Polymers with low T_{g} temperatures usually have low Tₘ values.

A polymer at a temperature above its T_{g}, is viscous and rubber-like, such that it can be stretched, perhaps several hundred percent, and upon being released will snap back to approximately its original length. Semi-crystalline polymers have improved elastic behavior above their T_{g} because sections of the polymer remain crystallized. These regions keep molecules tightly bound, improving the rubber-like elasticity. The T_{g} can be altered by the addition of plasticizers without compromising most of the desired polymer properties. A plasticizer is a small molecule which acts like a lubricant between two long polymer chains. As a general guideline adding 1% of a plasticizer yields a 3° C. decrease in T_{g}.

Polyglycolic acid (PGA) and polylactic acid are the most commonly uses synthetic bioerodible polymers today. PGA is highly crystalline and has a high melting point and low solubility in organic solvents. Lactic acid is chiral and has two stereoisomeric forms: D-PLA and L-PLA. L-PLA is semi-crystalline and the hydrolysis L-PLA yields L(+)lactic acid, the naturally occurring stereoisomer of lactic acid. To control degradation rate, copolymers of PGA and PLA are utilized. Lactic acid monomers are more hydrophobic than glycol acid, limiting the uptake of water and reducing the rate of backbone hydrolysis in the copolymer An object of the present invention is to provide a biodegradable polymer.

Another object is to provide a shrink wrap material fabricated from the biodegradable polymers.

A further object is to provide a resorbable thermo-conforming anastomosis-aiding device.

Still a further object is to provide an anastomosis-aiding device which can be placed over a bone fracture such that there is faster regeneration of bone and a more complete healing of the bone.

Yet still another object is to provide an anastomosis-aiding device for blood vessels, nerves, soft tissue, etc.

An additional object is to provide an anastomosis-aiding device which prevents any impinging tissue from entering a void and growing into the regeneration area.

These and other objects, features and advantages of the present invention will become apparent in light of the following detailed description of preferred embodiments thereof, as illustrated in the accompanying drawings.

### SUMMARY OF THE INVENTION

A biodegradable anastomosis-aiding device fabricated with a biodegradable polymer. The polymeric composition includes a mixture of lactic acid and polyglycolic acid. The mixture includes at least 75% lactic acid by weight. The polymeric composition maybe used to formulate a biodegradable thermo-conforming film used for anastomosis type of devices.

### BRIEF DESCRIPTION OF THE DRAWINGS

Other objects, features and advantages of the present invention will become more apparent as the description proceeds with reference to the accompanying drawings, wherein:

FIGS. 1A-B are cross-sectional views of a thermo-conforming sleeve being placed over a fractured bone and the sleeve after it has been shrunk into place;

FIGS. 2A-E are perspective views of biodegradable thermo-conforming sleeves in alternative shapes including a cylindrical tube, a split tube, an overlapped tube, a sutured tube and a wrap, respectively.

### DETAILED DESCRIPTION OF THE INVENTION

A biodegradable thermo-conforming anastomosis-aiding device may be fabricated using polymeric materials. Polyglycolic acid (PGA) and polylactic acid are the most commonly used synthetic bioerodible polymers. PGA is highly crystalline and has a high melting point and low solubility in organic solvents. Lactic acid is chiral and has two stereoisomeric forms: D-PLA and L-PLA. L-PLA is semi-crystalline and the hydrolysis L-PLA yields L(+)lactic acid, the naturally occurring stereoisomer of lactic acid. To control degradation rate, copolymers of PGA and PLA (available from Sigma-Aldrich) are utilized. Lactic acid monomers are more hydrophobic than glycol acid, limiting the uptake of water and reducing the rate of backbone hydrolysis in the copolymer.

L-PGLA attains the desired properties of the shrink wrap, provided the content of PLA is greater than 75%. Compositions greater than 25% glycolic acid would form a completely amorphous copolymer. In order for the polymer to be semi-crystalline, L-lactide, an atactic isomer is utilized.

The addition of glycolic acid to lactic acid to form a copolymer produces a T_{g} lower than PLA. However, it does not lower the T_{g} to a temperature below the tissue threshold temperature (45EC). In order to achieve lower T_{g} temperatures, a L-lactide monomer is added as a plasticizer. L-lactide (available from Sigma-Aldrich) is similar to the polymer, thus making it highly soluble. Plasticizers will reduce the Tₘ of the polymer within an acceptable range while only slightly altering the mechanical strength. The composition should have a glass transition temperature of between about 37-45° C. and a plasticizer of at least 3% by weight.

A resorbable thermo-conforming anastomosis-aiding sleeve placed over the bone void prior to fixation would protect the void and allow more complete healing through guided bone regeneration. The use of the anastomosis-aiding sleeve may also decrease the incidence of refracture while allowing a more normal use of the limb after the bone heals and decrease the number of screws necessary for fixation of comminuted fractures by holding bone fragments in place.

A preferred composition of the thermo-conforming anastomosis-aiding device includes 85:15 L-PLGA. The glycolic acid composition allows isomorphous replacement and reduces T_{g}. These factors were balanced with reduced crystallinity and mechanical strength associated with higher glycolic acid compositions.

In a shrink wrap material, the polymeric material must be heated above T_{g} and below Tₘ. The polymer is elongated and then quickly cooled below T_{g}. The percent of elongation of the polymeric material is between approximately 3 and 10%. This process will leave the polymer locked in an extended conformation. When the polymer is reheated above T_{g}, the polymer shrinks back to its previous state which is more entropically favorable.

The polymeric shrink wrap should meet certain functional requirements including availing a patient to a more complete and faster regeneration of bone or other type of tissue; the implantation/use of the anastomosis-aiding device must be minimally invasive to the patient; the surrounding tissue must be kept from collapsing or growing into the area of bone regeneration; bone fragments, grafts and implants must be retained in the void; an adequate blood supply must be available to the repairing bone; and infection, inflammation and scarring must be minimized.

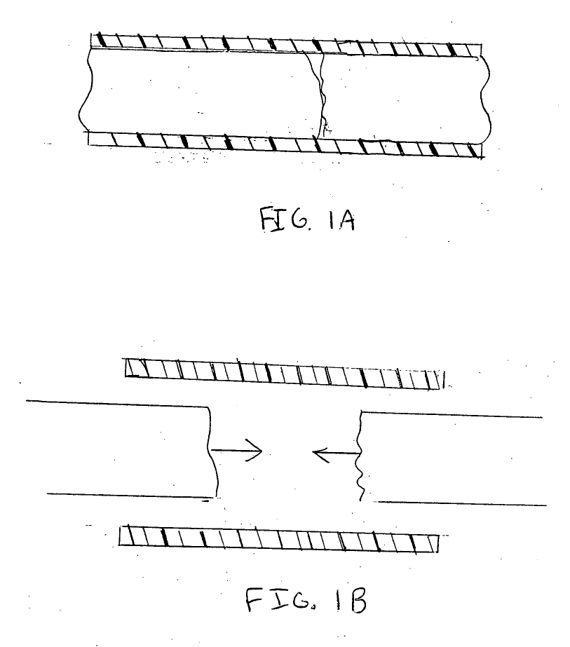

The polymeric shrink wrap may be in the form of a thin, tubular device that attaches to two fractured separated ends of bone or other type of tissue and surrounds the injured portion. FIG. 1A illustrates the two fractured ends of a fractured bone being placed within a thermo-conforming sleeve. The device is comprised of a shape memory polymer which may be initially formed as a compliant sheet or tube. After the polymer is raised to its glass transition temperature, it shrinks about 5%, and hardens to a slightly more rigid form. Thus, the device is initially pliable and easy to apply during surgery. With the aid of warm saline (approximately 42° C., below the tissue damage threshold,) poured around the device, it stiffens to a form a barrier between the healing bone or other type of tissue and any surrounding tissue, as seen in FIG. 1B. Furthermore, the device is resorbable and thus there is no need to remove the device after the fracture has healed. The device typically has a degradation time of approximately between 2 months and 2 years. After the thermo-forming anastomosis-aiding device is put in place and stiffened the bone may be set with conventional fixation techniques, i.e. screws, pins, plates etc.

The polymer can be readily manufactured with existing methods, while the plasticizer can be easily added after polymerization. Blow molding is a means for producing large quantities of hollow containers. The polymer is heated above T_{g} where it is injected through a hollow tube and inflated onto the wall of a cooled mold. The polymer conforms to the mold. The mold is opened and the container is removed.

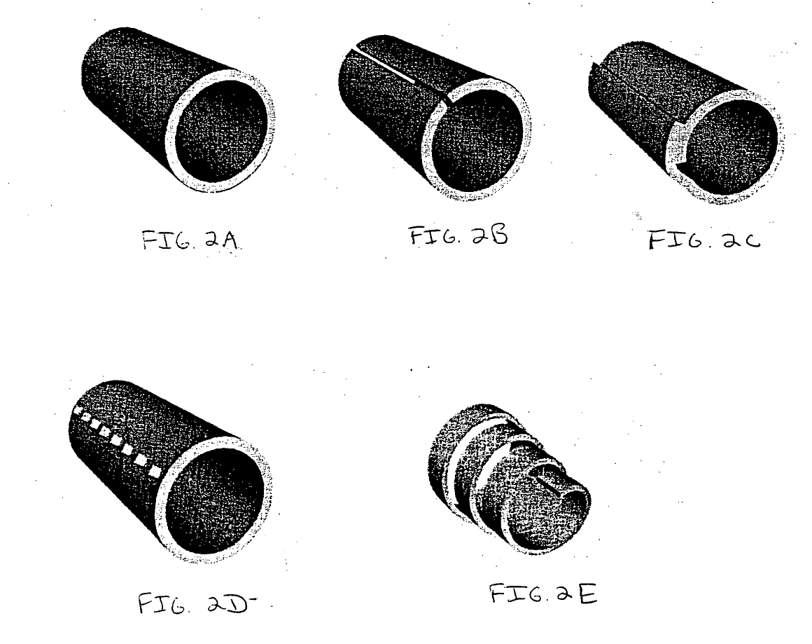

The anastomosis type of implant may be formed into various shapes including a complete tube, split tube, overlap tube, sutured tube or a wrap as seen in FIGS. 2A-E. The complete tube, the split tube, and the overlap tube appear most useful. The complete tube may be used in non-union and delayed union fractures whereas the overlap tube design is recommended for comminuted fractures and for used with bone grafts and implants where the purpose of the anastomosis-aiding device is to hold bone fragments in place without placing screws in individual fragments. The overlap design is easier to apply in situations with multiple fragments because the surgeon merely has to wrap the material around the assembled bone. The complete tube design will provide greater load bearing capability in non-union and delayed union fractures. To provide greater reinforcement, small strips of the material may be supplied with the two designs to wrap the two ends of the anastomosis in place.

The tubes may be of varying diameters and thicknesses for a multitude of fracture types and severity along with varying based on the diameter of the fractured bone. For example, multiple diameters are required to ensure a correct fit for different bone sizes whereas multiple thicknesses are necessary for different lengths of fracture. A longer fracture will require a thicker anastomosis to cope with the increase loads and stresses to which it will be subjected, but concurrently minimal thickness is desired to minimize inflammation and scarring. The anastomosis may be supplied in a single oversized length which the surgeon may cut to the desired length for the particular application.

An adequate blood supply flowing through the polymer is necessary to ensure healing of the fractured portion of the bone. Also the porosity of the thermo-conforming material should be minimized to ensure that fibroblasts cannot migrate into the healing bone. Thus, a solid sheet of polymeric material having a porosity of less than approximately 5 μm may be utilized.

The anastomosis-aiding sleeve has been described above in relation to the healing of a bone fracture. The sleeves may also be used with other fractured tissue such as blood vessels, nerves, soft tissue, etc.

Ethylene oxide sterilization is the ideal procedure for sterilization because it is performed at room temperature and is non-reactive with the polymer. It is vital that the procedure occurs below T_{g} to avoid premature activation of the device. It is also important that reactions such as hydrolysis or free radical formation do not occur since they would alter the molecular weight of the polymer. A less expensive sterilization method is gamma radiation, which may be used as an alternative form of sterilization as long as the decrease in molecular weight is deemed acceptable.

The design of the present invention attempts to solve some of the major drawbacks associated with current treatments. Tissue that collapses into a non-union fracture voids results in decreased bone regeneration. Thus, the diameter of the healed bone is smaller and the bone is more likely to refracture. Also, if impinging tissue could be restricted from the void, the bone would heal more fully and thus reduce bone refracture. The anastomosis protects the void and keeps the bone grafts or polymer matrices within the void.

Other potential methods of treatment focus on tissue engineering. Implantation of biodegradable polymer matrices, seeded with growth factors and bone cells, into the non-union voids. Although these treatments are only in the experimental stages, researchers have already encountered problems with surrounding tissues collapsing into the voids and displacing the matrices. The anastomosis may be used to restrain the tissue from entering the voids.

Although the present invention has been shown and described with respect to several preferred embodiments thereof, various changes, omissions and additions to the form and detail thereof, may be made therein, without departing from the spirit and scope of the invention.

What is claimed is:

1. A biodegradable shrink film comprising a mixture of lactic acid and polyglycolic acid, said mixture having at least 75% lactic acid by weight, such that said film is used to anastomose two fractured ends of tissue such that the tissue will heal.

2. The biodegradable shrinkable film of claim 1, wherein the lactic acid is polylactic acid.

3. The biodegradable shrinkable film of claim 1, wherein the polylactic acid is L-polylactic acid.

4. The biodegradable shrinkable film of claim 1, wherein the biodegradable composition includes a plasticizer.

5. The biodegradable shrinkable film of claim 4, wherein the plasticizer is L-lactide.

6. The biodegradable shrinkable film of claim 5, wherein said composition includes at least 3% by weight of said plasticizer is added.

7. The biodegradable shrinkable film of claim 5, wherein said composition has a glass transition temperature of between about 37-45° C.

8. The biodegradable shrinkable film of claim 5, wherein the percent of elongation is between approximately 3 and 10%.

9. The biodegradable shrinkable film of claim 8, wherein the degradation time of said film when positioned around the fractured ends of the tissue is approximately between 2 months and 2 years.

10. A biodegradable tubular device used to anastomose two fractured ends of tissue, said tubular device comprises a shrinkable film formed into a tube wherein said film comprises a mixture of lactic acid and polyglycolic acid, said mixture having at least 75% lactic acid by weight, said tube is shrunk in place over the two fractured ends of tissue to hold the tissue together, such that they will heal.

11. The biodegradable tubular device of claim 10, wherein the lactic acid is polylactic acid.

12. The biodegradable tubular device of claim 11, wherein the polylactic acid is L-polylactic acid.

13. The biodegradable tubular device of claim 10, wherein the biodegradable composition includes a plasticizer.

14. The biodegradable tubular device of claim 13, wherein the plasticizer is L-lactide.

15. The biodegradable tubular device of claim 14, wherein said composition includes at least 3% by weight of said plasticizer is added.

16. The biodegradable tubular device of claim 15, wherein said composition has a glass transition temperature of between about 37-45° C.

17. The biodegradable tubular device of claim 15, wherein the percent of elongation is between approximately 3 and 10%.

18. The biodegradable tubular device of claim 15, wherein the degradation time is approximately between 2 months and 2 years.

19. A biodegradable shrink film comprising a copolymer of lactic acid and polyglycolic acid, wherein said copolymer is at least 75% lactic acid by weight, such that said film is shrunk over two fractured ends of tissue.

20. The biodegradable shrinkable film of claim 19, wherein said copolymer is at least 85% lactic acid by weight.

21. The biodegradable shrinkable film of claim 19, wherein the lactic acid is polylactic acid.

22. The biodegradable shrinkable film of claim 21, wherein the polylactic acid is L-polylactic acid.

23. The biodegradable shrinkable film of claim 19, wherein the biodegradable copolymer includes a plasticizer.

24. The biodegradable shrinkable film of claim 23, wherein the plasticizer is L-lactide.

25. The biodegradable shrinkable film of claim 24, wherein said copolymer includes at least 3% by weight of said plasticizer is added.

26. The biodegradable shrinkable film of claim 25, wherein said copolymer has a glass transition temperature of between about 37-45° C.

27. The biodegradable shrinkable film of claim 25, wherein the percent of elongation is between approximately 3 and 10%.

28. The biodegradable shrinkable film of claim 25, wherein the degradation time of said film is approximately between 2 months and 2 years.

29. The biodegradable shrinkable film of claim 19, wherein the porosity is less than approximately 51 μm.

30. A method for anastomosing two ends of tissue, said method comprising the steps of:
a) placing a biodegradable shrink film around each end of tissue; and
b) increasing the temperature of the shrink film to its glass transition temperature, wherein the biodegradable shrink film comprises a mixture of lactic acid and polyglycolic acid having at least 75% lactic acid by weight.

31. The method of claim 30 wherein step b) is achieved by pouring warm saline around the biodegradable shrink film.

32. The method of claim 31 wherein the warm saline is approximately 42° C.

33. The method of claim 30 further comprising:
setting a fixation device around the two ends of tissue.

34. The method of claim 30 wherein there exists a space in between the two ends of tissue.

35. The method of claim 34 further comprising:
prior to step a), implanting a biodegradable matrix seeded with growth factors into the space between the two ends of tissue.

36. A method for preventing tissue from collapsing into a void, the method comprising:
placing a biodegradable shrink film over the void, wherein the biodegradable shrink film comprises a mixture of lactic acid and polyglycolic acid having at least 75% lactic acid by weight.
